(19) United States
(12) Patent Application Publication
(10) Pub. No.: US 2014/0228059 A1
(43) Pub. Date: Aug. 14, 2014

(54) ROOM AND FLOOR LEVEL POSITION LOCATION SCHEME

(71) Applicant: QUALCOMM INCORPORATED, San Diego, CA (US)

(72) Inventor: Ahmad JALALI, Rancho Santa Fe, CA (US)

(73) Assignee: QUALCOMM INCORPORATED, San Diego, CA (US)

(21) Appl. No.: 13/765,653

(22) Filed: Feb. 12, 2013

(51) Int. Cl. H04W 4/04

(52) U.S. Cl. CPC H04W 4/043
USPC 455/456.6

(57) ABSTRACT

Methods, systems, and devices are described for tracking an asset or person in an indoor environment and for validating the location of the asset or person. A location of a mobile tag attached to the asset or person is estimated and various candidate spaces within the indoor environment, such as rooms or hallways, are identified from the location estimate. Fixed tags deployed within each of the candidate spaces are scheduled to transmit energy signals such that fixed tags in different candidate spaces transmit energy signals at different times. The mobile tag receives instructions to detect energy signals at the various times that the fixed tags in the candidate spaces are scheduled to transmit the energy signals. The one candidate space in which the mobile tag is located may be identified based on which of the transmitted energy signals is detected.

### BACKGROUND

In some settings, such as in indoor environments, for example, it may be important to easily locate various types of assets and/or people. In a hospital setting, having the ability to track the location (e.g., room and floor) of a patient and/or the location of some medical equipment could prove critical in allowing the hospital staff to effectively provide the appropriate tests, diagnosis, and/or treatment to the patient. Other settings such as retail stores and warehouses, for example, can also use indoor tracking to locate assets and/or personnel.

Different systems and devices may be used to locate assets and/or people in a particular indoor environment. In one example, a WiFi network, or some other radio frequency network deployed throughout at least a portion of the indoor environment, may be configured to perform indoor tracking. In such a system, there may be multiple WiFi access points (APs), or WiFi anchor units, placed at specific locations in the indoor environment while a WiFi tag may be attached to each mobile asset or person to be tracked. The WiFi tag may send beacons or other signals that may be received by some of the WiFi access points. These WiFi access points in turn may send the information received from the WiFi tag to a server or to some other device to determine the location of the WiFi tag, and therefore, of the asset or person to which the WiFi tag is attached.

One of the challenges of WiFi-based indoor tracking systems is that their accuracy may not be sufficient to make them a reliable option for use in certain indoor environments such as hospital settings. The location estimate of a WiFi tag may have errors of several meters. In a hospital setting, where room-level accuracy may be needed, several meters of location estimate error may place a patient one or more rooms away from their actual room, perhaps even in the wrong floor. Even if one meter or sub-meter accuracy could be achieved, when the location estimate of the WiFi-tag attached to a patient places that patient near a wall, there is a likelihood that the patient is in the adjacent room on the other side of the wall. Overall, WiFi-based indoor tracking systems have no mechanism to verify or validate that the WiFi tag is actually in the room or floor associated with the location estimate.

Thus, to achieve accurate and cost-effective location tracking that is suitable for indoor environments, it may be desirable to use systems, methods, and devices that enable simple location validation schemes.

### SUMMARY

Methods, systems, and devices are provided that may address problems pertaining to effective asset and/or people tracking in an indoor environment. An indoor tracking system is described that uses a mobile tag attached to an asset or person to obtain a location estimate of that asset or person from measurements made by a radio frequency network. The indoor tracking system then uses the location estimate to synchronize the transmission and detection of energy signals to accurately determine and validate the space (e.g., room, hallway) in which the asset or person is present.

Once the location estimate of a mobile tag is available, the corresponding asset or person is initially associated with a particular space in the indoor environment. Because the location estimate has an inherent error, there is a likelihood that the asset or person is not in the initial space but in an adjacent or nearby space. As a result, a set of candidate spaces may be generated based on the likelihood that the asset or person is located in one of those spaces. Then, a fixed tag within each candidate space receives an instruction to transmit an energy signal at a particular time. On the other hand, the mobile tag is instructed to read or detect energy signals during the same times as the energy signals from the fixed tags of the different candidate spaces are transmitted. The timing of the instructions to both the fixed tags and the mobile tag are scheduled based on a ranking of the candidate spaces in the set. When the mobile tag detects an energy signal it reports the detection to the radio frequency network, which in turn identifies the candidate space within which the energy signal transmission occurred at the same time as energy signal detection by the mobile tag.

A method for indoor tracking includes determining two or more candidate spaces for a device in an indoor environment based on an estimate of a location of the device. The location estimate of the device may be determined based on information in one or more signals transmitted by the device. The method also includes scheduling transmission of at least one energy signal from within each of the two or more candidate spaces at a different time and scheduling energy detection for the device at the different times that the energy signals are being transmitted from within each of the two or more candidate spaces. The at least one energy signal may include an ultrasound signal. The at least one energy signal may include an ultrasound signal having one or more bits of information about the corresponding candidate space. The method further includes identifying, based on which of the transmitted energy signals detected by the device, the one candidate space of the two or more candidate spaces in which the device is located. Information may be received that identifies which of the transmitted energy signals is detected by the device.

In some embodiments, each of the two or more candidate spaces is ranked based on the likelihood that the device is located in the candidate space being ranked. Based on the ranking of the two or more candidate spaces, a schedule is determined that coordinates the transmission of energy signals from within each of the two or more candidate spaces and the detection by the device of the transmitted energy signals.

Another method for indoor tracking includes transmitting, by a device, information to determine an estimate of a location of the device in an indoor environment. The method also includes receiving an instruction to enable the device to detect energy signals for a specified period of time, where the instruction is scheduled based on two or more candidate spaces for the device that are obtained from the location estimate of the device. The device may be woken up from a dormant state in response to the instruction being received and may be returned to dormant state in response to the specified period of time being over. The method further includes reporting whether an energy signal is detected during the specified period of time to determine the candidate space of the two or more candidate spaces in which the device is located.

In some embodiments, an energy signal that includes an ultrasound signal is detected during the specified period of time. The energy signal detected during the specified period of time may include an ultrasound signal having one or more bits of information about the corresponding candidate space.

A system for indoor tracking includes means for determining two or more candidate spaces for a device in an indoor environment based on an estimate of a location of the device. The system also includes means for scheduling transmission of at least one energy signal from within each of the two or more candidate spaces at a different time and means for scheduling energy detection for the device at the different times that the energy signals are being transmitted from within each of the two or more candidate spaces. The at least one energy signal may include an ultrasound signal. The at least one energy signal may include an ultrasound signal having one or more bits of information about the corresponding candidate space. The system further includes means for identifying, based on which of the transmitted energy signals is detected by the device, the one candidate space of the two or more candidate spaces in which the device is located.

In some embodiments, the system includes means for ranking each of the two or more candidate spaces based on the likelihood that the device is located in the candidate space being ranked. The system also includes means for determining, based on the ranking of the two or more candidate spaces, a schedule that coordinates the transmission of energy signals from within each of the two or more candidate spaces and the detection by the device of the transmitted energy signals.

In some embodiments, the system includes means determining the location estimate of the device based on information in one or more signals transmitted by the device. The system may also include means for receiving information that identifies which of the transmitted energy signals is detected by the device.

Another system for indoor tracking includes means for transmitting, by a device, information to determine an estimate of a location of the device in an indoor environment. The system also includes means for receiving an instruction to enable the device to detect energy signals for a specified period of time, where the instruction is scheduled based on two or more candidate spaces for the device that are obtained from the location estimate of the device. The system further includes means for reporting whether an energy signal is detected during the specified period of time to determine the candidate space of the two or more candidate spaces in which the device is located.

In some embodiments, the system includes means for detecting during the specified period of time, an energy signal that includes an ultrasound signal. The system may include means for detecting during the specified period of time, an energy signal that includes an ultrasound signal having one or more bits of information about the corresponding candidate space. The system may also include means for waking up the device from a dormant state in response to the instruction being received and means for returning the device to the dormant state in response to the specified period of time being over.

A device for indoor tracking includes at least one processor communicatively coupled with a memory, where the memory has executable code that, when executed by the at least one processor, causes the at least one processor to determine two or more candidate spaces for the device in an indoor environment based on an estimate of a location of the device. The executable code also causes the at least one processor to schedule transmission of at least one energy signal from within each of the two or more candidate spaces at a different time and to schedule energy detection for the device at the different times that the energy signals are being transmitted from within each of the two or more candidate spaces. The at least one energy signal may include an ultrasound signal. The at least one energy signal may include an ultrasound signal having one or more bits of information about the corresponding candidate space. The executable code further causes the at least one processor to identify, based on which of the transmitted energy signals is detected by the device, the one candidate space of the two or more candidate spaces in which the device is located. The executable code may also cause the at least one processor to receive information that identifies which of the transmitted energy signals is detected by the device.

In some embodiments, the executable code causes the at least one processor to determine the location estimate of the device based on information in one or more signals transmitted by the device. The executable code may also cause the at least one processor to rank each of the two or more candidate spaces based on the likelihood that the device is located in the candidate space being ranked. The executable code may also cause the at least one processor to determine, based on the ranking of the two or more candidate spaces, a schedule that coordinates the transmission of energy signals from within each of the two or more candidate spaces and the detection by the device of the transmitted energy signals.

Another device for indoor tracking includes at least one processor communicatively coupled with a memory, where the memory has executable code that, when executed by the at least one processor, causes the at least one processor to transmit information to determine an estimate of a location of the device in an indoor environment. The executable code also causes the at least one processor to receive an instruction to enable the device to detect energy signals for a specified period of time, where the instruction is scheduled based on two or more candidate spaces for the device that are obtained from the location estimate of the device. The executable code may cause the at least one processor to wake up the device from a dormant state in response to the instruction being received and to return the device to the dormant state in response to the specified period of time being over. The executable code further causes the at least one processor to report whether an energy signal is detected during the specified period of time to determine the candidate space of the two or more candidate spaces in which the device is located.

In some embodiments, the executable code causes the at least one processor to detect during the specified period of time, an energy signal that includes an ultrasound signal. The executable code may cause the at least one processor to detect during the specified period of time, an energy signal that includes an ultrasound signal having one or more bits of information about the corresponding candidate space.

A computer program product for indoor tracking includes a non-transitory computer-readable medium having code configured to determine two or more candidate spaces for a device in an indoor environment based on an estimate of a location of the device. The non-transitory computer-readable medium also has code configured to schedule transmission of at least one energy signal from within each of the two or more candidate spaces at a different time and code configured to schedule energy detection for the device at the different times that the energy signals are being transmitted from within each of the two or more candidate spaces. The at least one energy signal may include an ultrasound signal. The at least one energy signal may include an ultrasound signal having one or more bits of information about the corresponding candidate space. The non-transitory computer-readable medium further has code configured to identify, based on which of the transmitted energy signals is detected by the device, the one candidate space of the two or more candidate spaces in which the device is located. The non-transitory computer-readable medium may have code configured to receive information that identifies which of the transmitted energy signals is detected by the device.

In some embodiments, the non-transitory computer-readable medium has code configured to determine the location estimate of the device based on information in one or more signals transmitted by the device. The non-transitory computer-readable medium comprises may have code configured to rank each of the two or more candidate spaces based on the likelihood that the device is located in the candidate space being ranked. The non-transitory computer-readable medium may have code configured to determine, based on the ranking of the two or more candidate spaces, a schedule that coordinates the transmission of energy signals from within each of the two or more candidate spaces and the detection by the device of the transmitted energy signals.

Another computer program product for indoor tracking includes a non-transitory computer-readable medium having code configured to transmit, by a device, information to determine an estimate of a location of the device in an indoor environment. The non-transitory computer-readable medium also has code configured to receive an instruction to enable the device to detect energy signals for a specified period of time, the instruction being scheduled based on two or more candidate spaces for the device that are obtained from the location estimate of the device. The non-transitory computer-readable medium further has code configured to report whether an energy signal is detected during the specified period of time to determine the candidate space of the two or more candidate spaces in which the device is located.

In some embodiments, the non-transitory computer-readable medium has code configured to detect during the specified period of time, an energy signal that includes an ultrasound signal. The non-transitory computer-readable medium may have code configured to detect during the specified period of time, an energy signal that includes an ultrasound signal having one or more bits of information about the corresponding candidate space. The non-transitory computer-readable medium may have code configured to wake up the device from a dormant state in response to the instruction being received and code configured to return the device to the dormant state in response to the specified period of time being over.

Another method for indoor tracking includes determining two or more candidate spaces for a device in an indoor environment based on an estimate of a location of the device. The location estimate of the device may be determined based on information in one or more signals transmitted by the device. The method also includes scheduling transmission of at least one energy signal from the device during a period of time and scheduling energy detection from within each of the two or more candidate spaces during the same period of time as the scheduled transmission from the device. The at least one energy signal may include an ultrasound signal. The method further includes identifying, based on the candidate space within which the at least one energy signal transmitted by the device is detected, the one candidate space of the two or more candidate spaces in which the device is located.

Another system for indoor tracking includes means for determining two or more candidate spaces for a device in an indoor environment based on an estimate of a location of the device. The location estimate of the device may be determined based on information in one or more signals transmitted by the device. The system also includes means for scheduling transmission of at least one energy signal from the device during a period of time and means for scheduling energy detection from within each of the two or more candidate spaces during the same period of time as the scheduled transmission from the device. The at least one energy signal may include an ultrasound signal. The system further includes means for identifying, based on the candidate space within which the at least one energy signal transmitted by the device is detected, the one candidate space of the two or more candidate spaces in which the device is located.

Another device for indoor tracking includes at least one processor communicatively coupled with a memory, where the memory has executable code that, when executed by the at least one processor, causes the at least one processor to determine two or more candidate spaces for a device in an indoor environment based on an estimate of a location of the device. The location estimate of the device may be determined based on information in one or more signals transmitted by the device. The executable code also causes the at least one processor to schedule transmission of at least one energy signal from the device during a period of time and schedule energy detection from within each of the two or more candidate spaces during the same period of time as the scheduled transmission from the device. The at least one energy signal may include an ultrasound signal. The executable code further causes the at least one processor to identify, based on the candidate space within which the at least one energy signal transmitted by the device is detected, the one candidate space of the two or more candidate spaces in which the device is located.

Another computer program product for indoor tracking includes a non-transitory computer-readable medium having code configured to determine two or more candidate spaces for a device in an indoor environment based on an estimate of a location of the device. The location estimate of the device may be determined based on information in one or more signals transmitted by the device. The non-transitory computer-readable medium also has code configured to schedule transmission of at least one energy signal from the device during a period of time and code configured to schedule energy detection from within each of the two or more candidate spaces during the same period of time as the scheduled transmission from the device. The at least one energy signal includes an ultrasound signal. The non-transitory computer-readable medium further includes code configured to identify, based on the candidate space within which the at least one energy signal transmitted by the device is detected, the one candidate space of the two or more candidate spaces in which the device is located.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a location tracking system according to various embodiments;

FIG. 2A shows a block diagram of an example of a mobile tag unit according to various embodiments;

FIG. 2B shows a block diagram of another example of a mobile tag unit according to various embodiments;

FIG. 3 shows a block diagram of an example of an anchor unit according to various embodiments;

FIG. 4 shows a block diagram of an example of a location tracking server according to various embodiments;

FIG. 5A shows a block diagram of an example of a fixed tag unit according to various embodiments;

FIG. 5B shows a block diagram of another example of a fixed tag unit according to various embodiments;

FIGS. 6A-6D show diagrams that illustrate an example of a location validation scheme according to various embodiments;

FIG. 7 shows a diagram that illustrates an example of validation ranking in a location validation scheme according to various embodiments;

FIG. 8 shows a diagram that illustrates another example of a location validation scheme according to various embodiments;

FIG. 9 is a flowchart of an example of a method for indoor location tracking with a location validation scheme according to various embodiments;

FIG. 10 is a flowchart of another example of a method for indoor location tracking with a location validation scheme according to various embodiments;

FIG. 11 is a flowchart of yet another example of a method for indoor location tracking with a location validation scheme according to various embodiments; and

FIG. 12 is a flowchart of yet another example of a method for indoor location tracking with a location validation scheme according to various embodiments.

### DETAILED DESCRIPTION

Methods, systems, and devices are provided that may address problems pertaining to effective asset and/or people tracking in an indoor environment. An indoor tracking system is described that uses a mobile tag attached to an asset or person to obtain a location estimate of that asset or person from measurements made by a radio frequency network. For example, anchor units deployed throughout the indoor environment receive beacon signals or other types of signals wirelessly transmitted from a mobile tag and the information obtained from the signals is used to estimate the location of the mobile tag. The indoor tracking system then uses the location estimate to synchronize the transmission and detection of energy signals to accurately determine and validate the space (e.g., room, hallway) in which the asset or person is present.

Once the location estimate of a mobile tag is available, the corresponding asset or person is initially associated with a particular space in the indoor environment. Because the location estimate has an inherent error, there is a likelihood that the asset or person is not in the initial space but in an adjacent or nearby space. As a result, a set of candidate spaces may be generated based on the likelihood that the asset or person is located in one of those spaces. Then, a fixed tag within each candidate space receives an instruction to transmit an energy signal at a particular time. On the other hand, the mobile tag is instructed to read or detect energy signals during the same times as the energy signals from the different candidate spaces are transmitted. The timing of the instructions to both the fixed tags and the mobile tag are scheduled based on a ranking of the candidate spaces in the set. When the mobile tag detects an energy signal it reports the detection to the radio frequency network, which in turn identifies the candidate space within which the energy signal transmission occurred at the same time as energy signal detection by the mobile tag.

Because the fixed tags do not need to transmit energy signals until they receive a scheduled instruction to do so, the fixed tags may remain dormant and wake up only when the instruction to transmit an energy signal is received. After the energy signal is transmitted, the fixed tag may go back to a dormant or inactive state. Similarly, because the mobile tags do not need to detect the transmission of energy signals until they receive a scheduled instruction to do so, the mobile tags may remain dormant and wake up only when the instruction to detect an energy signal is received. After the period for detecting the energy signal is over, the mobile tag may go back to a dormant state. By being dormant for long periods of time, both the fixed tags and the mobile tags may save power and could be configured to be operated by batteries.

A similar location validation scheme to the one described above may be followed when multiple assets and/or persons are being tracked concurrently within the indoor environment. In such a scenario, proper coordination and scheduling is needed between the transmission of the energy signals by the fixed tags in the candidate spaces and the detection of those energy signals by the various mobile tags used to track the multiple assets and/or persons.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

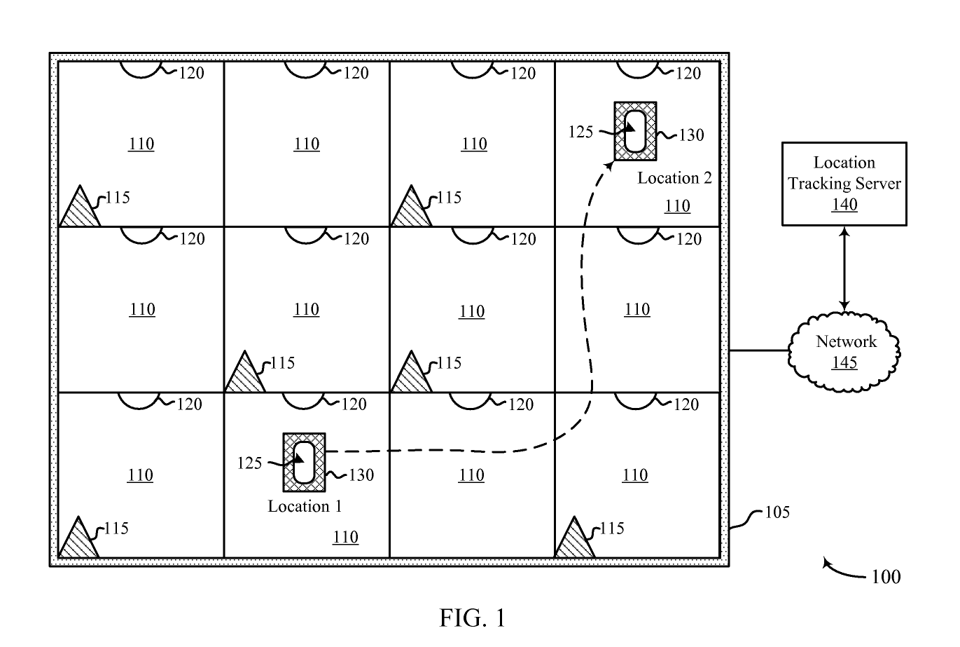

Referring first to FIG. 1, a block diagram illustrates an example of a location tracking system 100 in accordance with various embodiments. The system 100 provides location tracking across a coverage area 105 associated with an indoor or enterprise environment. For example, the coverage area 105 may represent an area of coverage inside a building, hospital, store, warehouse, or some other type of facility. The coverage area 105 includes multiple spaces 110, each of which represents a particular room, hallway, or enclosed area within the indoor or enterprise environment. In FIG. 1, adjacent spaces 110 in the coverage area 105 may represent spaces that are next to each other in the same floor of a building or may represent overlapping spaces in contiguous floors of a building. Identifying one of the spaces 110 may therefore identify the floor or level within the building where that particular space 110 is located.

In the coverage area 105, there are deployed multiple anchor units 115 at specific locations. Typically, an anchor unit 115 need not be placed in each of the spaces 110. One of the anchor units 115 may be used as a reference and may be referred to as the reference anchor unit. Because of their stationary nature, the exact distance between any two of the anchor units 115 may be known throughout the operation of the system 100. The anchor units 115 may be used for indoor location tracking of assets and/or people and for validating the location estimates resulting from tracking of those assets and/or people. In some embodiments, the anchor units 115 may be associated with a radio frequency network such as an ultra-wideband (UWB) network, for example.

The system 100 includes a location tracking server 140 that is connected to the anchor units 115 within the coverage area 105 through a network 145. The location tracking server 140 may receive information from the anchor units 115 to perform various types of calculations associated with indoor location tracking. Some of the calculations include, but are not limited to, distance calculations, clock offset calculations, and triangulation or trilateration calculations to estimate a location of an asset or person within the coverage area 105. The location tracking server 140 may schedule or coordinate various operations associated with the anchor units 115 including when to have an anchor unit 115 wirelessly communicate with other anchor units 115 to determine clock offsets for synchronization.

The anchor units 115 may receive wireless transmissions (e.g., preamble signals or beacon signals) from a mobile tag unit 125 that is attached to a mobile asset or person 130 being tracked. The mobile tag unit 125 may be a battery-operated device that periodically sends wireless transmissions to identify itself to the system 100. The information from the wireless transmissions may be received by the anchor units 115, typically those closest to the mobile tag unit 125, and those anchor units 115 may collect, process, and store the information. For example, one of the anchor units 115 may use the information provided by the mobile tag unit 125 to determine a distance between that anchor unit 115 and the mobile tag unit 125. That distance calculation may be sent to the location tracking server 140 for further processing. In some embodiments, the anchor unit 115 collects the information from the mobile tag unit 125 and sends the information to the location tracking server 140 to make the distance calculations and for further processing. In some embodiments, the distance calculations from four or more anchor units 115 may be used to estimate the location of the mobile tag unit 125 within the coverage area 105. The location tracking server 140 may use the location estimate to identify an initial space 110 as the space where the mobile asset or person 130 appears to be located, and may use a location estimate error to determine a set of spaces 110 (i.e., candidate spaces) where the mobile asset or person 130 is likely to be located.

In the coverage area 105, there are also deployed multiple fixed tag units 120, with at least one fixed tag unit 120 in each of the spaces 110. Like the anchor units 115, the fixed tag units 120 may be placed at specific locations within each of the spaces 110. In some embodiments, the fixed tag units 120 may be battery-operated devices that may be easily deployed and maintained within the coverage area 105. The fixed tag units 120 may be used as part of a location validation scheme to transmit energy signals for detection by the mobile tag unit 125. The energy signals may include acoustic signals (e.g., ultrasound signals) or optical signals (e.g., optical beams). The fixed tag units 120 may wirelessly receive instructions from one or more neighboring anchor units 115, where the instructions indicate when to transmit the energy signals. Similarly, the mobile tag unit 125 may wirelessly receive instructions from one or more neighboring anchor units 115, where the instructions indicate when to expect energy signals to be transmitted. The instructions may be scheduled by the location tracking system 140 based on the candidate spaces in which it is likely that the mobile asset or person 130 is located. When mobile tag unit 125 detects energy signals transmitted from the fixed tag unit 120 within a particular space 110, the mobile tag unit 125 reports the detection to the neighboring anchor units 115, which in turn provide the information to the location tracking server 140 to validate that particular space 110 as the one where the asset or person 130 is located.

In other embodiments, the fixed tag units 120 may be used as part of a location validation scheme to detect energy signals transmitted by the mobile tag unit 125. The energy signals may include acoustic signals (e.g., ultrasound signals) or optical signals (e.g., optical beams). The fixed tag units 120 may wirelessly receive instructions from one or more neighboring anchor units 115, where the instructions indicate a period of time during which the fixed tag units 120 are to detect the energy signals. Similarly, the mobile tag unit 125 may wirelessly receive instructions from one or more neighboring anchor units 115, where the instructions indicate the period of time during which the mobile tag unit 125 is to transmit the energy signals. The instructions may be scheduled by the location tracking system 140 based on the candidate spaces in which it is likely that the mobile asset or person 130 is located. When one of the fixed tag units 120 detects energy signals transmitted by the mobile tag unit 125 from within a particular space 110, the fixed tag unit 120 that made the detection then reports the detection to the neighboring anchor units 115, which in turn provide the information to the location tracking server 140 to validate that particular space 110 as the one where the asset or person 130 is located.

An example of the operation of the system 100 of FIG. 1 is described next. The anchor units 115 are first synchronized by determining their clock offsets. Once the clock offsets are known, range measurements between some of the anchor units 115 and the mobile tag unit 125 are made based on information provided by the mobile tag unit 125. These range measurements are then used by the system 100 to identify the location of the mobile tag unit 125. At first, the mobile tag unit 125 is estimated to be at or near a location 1. Based on the estimate and on errors in the estimate, the system 100 may then perform a location validation scheme to determine the correct space 110 (e.g., room) within the coverage area 105 where the mobile tag unit 125 is actually located. In some instances, the initial space may be correct while in other cases the location validation scheme may identify a different space as the correct space. This approach may allow room-level accuracy to be achieved even in those instances when there is some ambiguity about the actual location of the mobile tag unit 125. Over time, the mobile asset or person 130 changes to a different location and the same process as described above may be performed along the way. At a later time, the mobile tag unit 125 is estimated to be at or near a location 2, thereby tracking the movement of the mobile asset or person 130 from location 1 to location 2. Moreover, once at location 2, the system 100 may perform a location validation scheme if there is some ambiguity from the location estimate as to the actual location of the mobile tag unit 125.

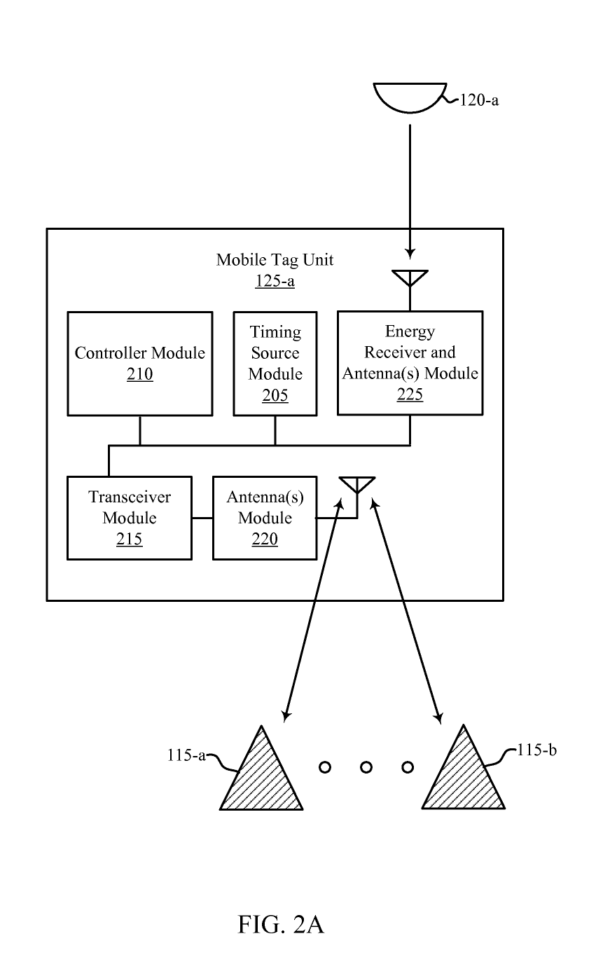

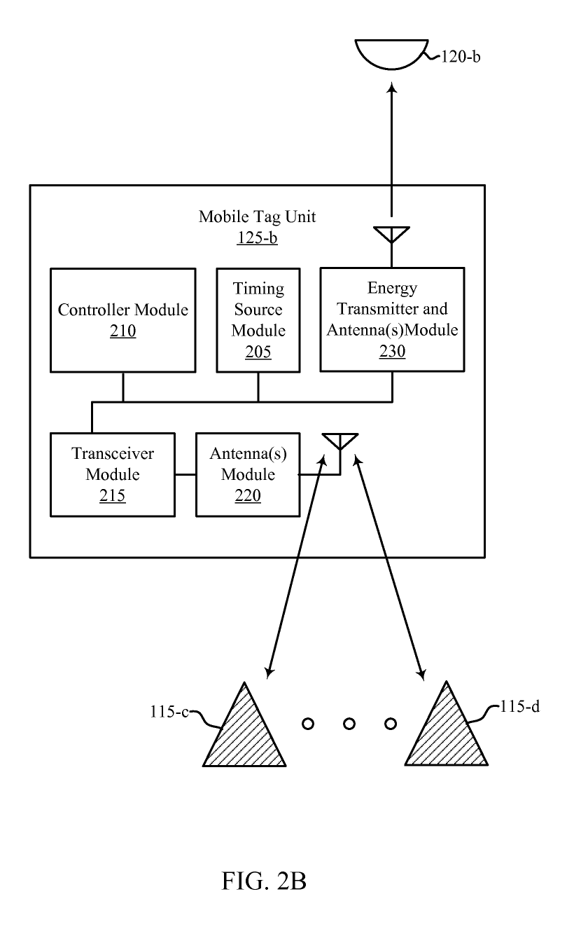

Turning now to FIG. 2A, there is shown a mobile tag unit 125-a that may be an example of the mobile tag unit 125 of FIG. 1. The mobile tag unit 125-a includes a timing source module 205, a controller module 210, a transceiver module 215, an antenna(s) module 220, and an energy receiver and antenna(s) module 225. Although not shown in FIG. 2A, the mobile tag unit 125-a may also include a battery that enables the mobile tag unit 125-a to be used as a battery-operated device. Each of these components may be in communication, directly or indirectly.

The timing source module 205 produces a clock and/or some other timing signal that is used by the mobile tag unit 125-a to generate preamble or beacon signals for broadcasting. In some embodiments, the timing source module 205 may include an oscillator and/or a frequency synthesizer that produces the appropriate clock for the operation of the mobile tag unit 125-a. For example, the clock may be used to enable detection of energy signals through the energy receiver and antenna(s) module 225 during the appropriate time periods.

The controller module 210 may include logic and/or code that enables it to control the operations of the mobile tag unit 125-a. For example, the controller module 210 may include a processor, a microcontroller, and/or a state machine to generate preamble or beacon signals for periodic transmission. The signals typically include information that identifies the mobile tag unit 125-a and distinguishes it from other tag units. The controller module 210 may also handle instructions that indicate when the mobile tag unit 125-a is to expect energy signals to be transmitted from a fixed tag unit 120-a and to ready the energy receiver and antenna(s) module 225 to detect the energy signals. The controller module 210 may report to one or more of anchor units 115-a through 115-b when an energy signal is detected. Moreover, the controller module 210 may wake up the mobile tag unit 125-a from a dormant state in response to an instruction being received and may return the mobile tag unit 125-a to the dormant state after some specified period of time.

The transceiver module 215 may support a radio frequency (RF) communication technology to broadcast preamble signals through the antenna(s) module 220. For example, the transmitter module 215 may include a modulator (not shown) to modulate preamble information and provide the modulated preamble information to the antenna(s) module 220 for transmission as preamble signals. As shown in FIG. 2A, the preamble signals that are broadcast from the mobile tag unit 125-a may be received by one or more anchor units. In this example, the mobile tag unit 125-a is shown to broadcast preamble signals to anchor units 115-a through 115-b. While some examples of the antenna(s) module 220 may include a single antenna, the antenna(s) module 220 may include multiple antennas.

The transceiver module 215 may include a demodulator (not shown) to demodulate data that includes instructions for detecting energy signals through the energy receiver and antenna(s) module 225. In some embodiments, the modulator and demodulator described above may be implemented as a modem. As shown in FIG. 2A, the data having the energy detection instructions may be received by the mobile tag unit 125-a from one or more of the anchor units 115-a through 115-b. In some instances, the set of anchor units from which the data with energy detection instructions may be transmitted is different from the set of anchor units that may receive the preamble signals transmitted by the mobile unit 125-a.

The energy receiver and antenna(s) module 225 may detect energy signals (e.g., ultrasound signals, optical signals) when instructed to look out for those signals. The energy receiver and antenna(s) module 225 may generate an indication that an energy signal has been detected during a detection period and may provide that indication to the controller module 210, which in turn may generate a report to be transmitted to the anchor units 115-a through 115-b. In some instances, the energy signals may include information about the fixed tag unit 120-b and the mobile tag unit 125-a may include that information in the report. While some examples of the energy receiver and antenna(s) module 225 may include a single antenna, the energy receiver and antenna(s) module 225 may include multiple antennas.

Turning now to FIG. 2B, there is shown a mobile tag unit 125-b that may be an example of the mobile tag units 125 of FIG. 1. The mobile tag unit 125-b includes the timing source module 205, the controller module 210, the transceiver module 215, and the antenna(s) module 220 of the mobile tag unit 125-a of FIG. 2A, as well as an energy transmitter and antenna(s) module 230. Although not shown in FIG. 2B, the mobile tag unit 125-b may also include a battery that enables the mobile tag unit 125-b to be used as a battery-operated device. Each of these components may be in communication, directly or indirectly.

In this example, the clock produced by the timing source module 205 may be used to enable transmission of energy signals through the energy transmitter and antenna(s) module 230 during the appropriate time periods. The energy signals may be received by a fixed tag unit associated by a particular space as illustrated by a fixed tag unit 120-b. The controller module 210 may handle instructions that indicate when the mobile tag unit 125-b is to transmit energy signals and to ready the energy transmitter and antenna(s) module 230 to transmit the energy signals. The data having the energy transmission instructions may be received by the mobile tag unit 125-b from one or more of anchor units 115-c through 115-d, for example. The energy transmitter and antenna(s) module 230 may generate and transmit energy signals (e.g., ultrasound signals, optical signals) during a particular period of time when instructed to do so.

In some embodiments, at least a portion of the features and/or functions of the mobile tag unit 125-a of FIG. 2A and of the mobile tag unit 125-b of FIG. 2B may be combined into a single mobile tag unit.

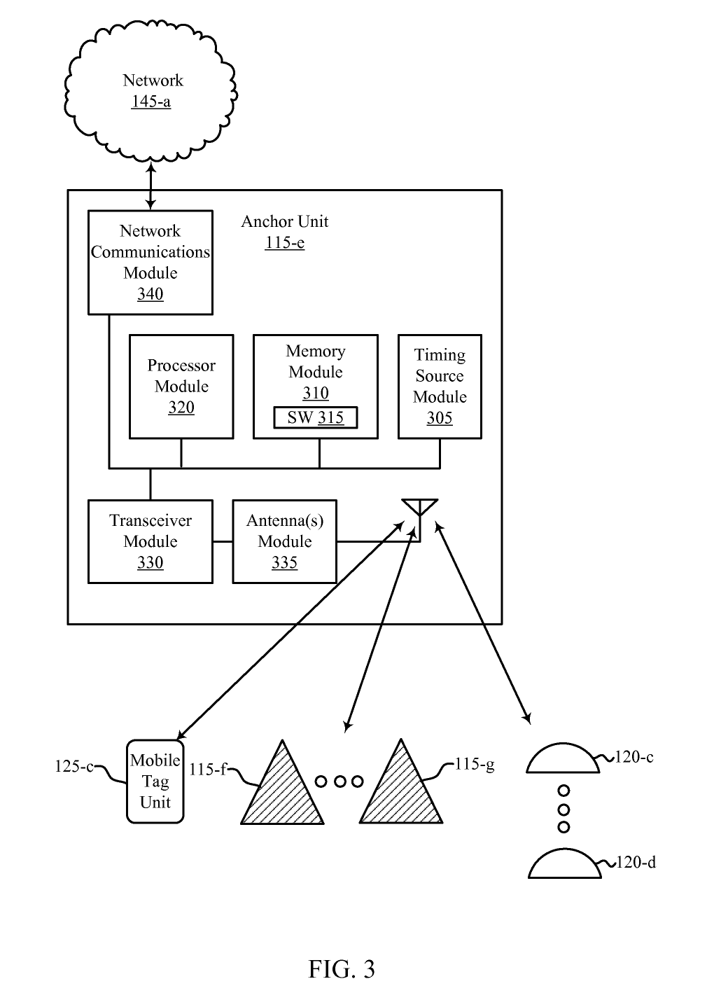

Turning to FIG. 3, an anchor unit 115-e is shown that may be an example of the anchor units 115, 115-a through 115-b, and 115-c through 115-d of FIG. 1, FIG. 2A and FIG. 2B. The anchor unit 115-e includes a timing source module 305, a memory module 310, a processor module 320, a transceiver module 330, antenna(s) module 335, and a network communications module 340. Each of these components may be in communication, directly or indirectly.

The timing source module 305 produces a clock and/or some other timing signal that is used by the anchor unit 115-e during operations. In some embodiments, the timing source module 305 may include an oscillator and/or a frequency synthesizer that produces the appropriate clock for the operation of the anchor unit 115-e. The clock used by the anchor unit 115-e may be offset from the clock used by other anchor units and/or from the clock used by a mobile tag unit such as a mobile tag unit 125-c. To compensate for the clock offset, particularly during range measurements used to estimate the location of a mobile tag unit, the anchor unit 115-e may send and/or receive information from other anchor units to determine the clock offset between the anchor unit 115-e and those other anchor units. These clock offsets may then be used to synchronize the anchor units to improve the location estimate of the mobile tag unit 125-c.

The memory module 310 may include random access memory (RAM) and read-only memory (ROM). The memory module 310 may also store computer-readable, computer-executable software (SW) code 315 containing instructions that are configured to, when executed, cause the processor module 320 to perform various functions described herein (e.g., range measurements, distance calculations, clock offset determination, instruction transmission). Alternatively, the software code 315 may not be directly executable by the processor module 320 but be configured to cause the computer, e.g., when compiled and executed, to perform functions described herein.

The processor module 320 may include an intelligent hardware device, e.g., a central processing unit (CPU) such as those made by Intel® Corporation or AMD®, a microcontroller, an application-specific integrated circuit (ASIC), etc. The processor module 320 may perform various operations associated with synchronizing the anchor unit 115-e to other anchor units. For example, the processor module 320 may be used to generate data and prepare that data for transmission to another anchor unit to determine a clock offset between the anchor unit 115-e and the other anchor unit. The processor module 320 may use scheduling information received from, for example, the location tracking server 140, to determine which signals to generate and when to transmit the signals for determining a clock offset between the anchor unit 115-e and another anchor unit.

The processor module 320 may also perform various operations associated with a location validation scheme. For example, the processor module 320 may receive information from a location tracking server (e.g., location tracking server 140) that indicates when to transmit instructions to one or more of fixed tag units 120-c through 120-d regarding the transmission of energy signals from the fixed tag units. Similarly, the processor module 320 may receive information that indicates when to transmit instructions to the mobile tag unit 125-c regarding the detection of energy signals transmitted from one or more of the fixed tag units 120-c through 120-d. The processor module 320 may also receive and handle reports transmitted by the mobile tag unit 125-c that indicate when, and if, energy signals were detected. The processor module 320 may communicate this information to a network 145-a through the network communications module 340.

The processor module 320 may perform other functions in connection with a validation scheme. For example, the processor module 320 may receive information from a location tracking server (e.g., location tracking server 140) that indicates when to transmit instructions to the mobile tag unit 125-c regarding the transmission of energy signals from the mobile tag unit 125-c. Similarly, the processor module 320 may receive information that indicates when to transmit instructions to the fixed tag units 120-c through 120-d regarding the detection of energy signals transmitted from the mobile tag unit 125-c. The processor module 320 may also receive and handle reports transmitted by the fixed tag unit that detects the energy signal transmission. The processor module 320 may communicate this information to the network 145-a through the network communications module 340.

The transceiver module 330 may include a modem (not shown) configured to modulate the data (e.g., packets) and provide the modulated data to the antenna(s) module 335 for transmission, and to demodulate data received from the antenna(s) module 335. While some examples of the anchor unit 115-e may include a single antenna, the anchor unit 115-e may include multiple antennas. As shown in FIG. 3, preamble signals that are broadcast by the mobile tag unit 125-c, as well as report signals transmitted by the mobile tag unit 125-c, may be received by the anchor unit 115-e through the antenna(s) in the antenna(s) module 335. Signals with instructions for the mobile tag unit 125-c and/or for one or more of the fixed tag units 120-c through 120-d may be sent through the antenna(s) in the antenna(s) module 335. In some embodiments, the transceiver module 330 receives one or more reports from the mobile tag unit 125-c that indicate which space contains the mobile tag unit 125-c. In other embodiments, the transceiver module 330 receives one or more reports from one of the fixed tag units 120-c through 120-d that indicate which space contains the mobile tag unit 125-c. The anchor unit 115-e may wirelessly communicate with other anchor units such as anchor units 115-f through 115-g, for example.

In some embodiments, the transceiver module 330 and/or the antenna(s) module 335 may support multiple RF communications technologies. For example, UWB communications as well as the unlicensed Industrial, Scientific, and Medical (ISM) band (e.g., 2.4 Gigahertz) communications may be concurrently supported by the transceiver module 330 and/or the antenna(s) module 335. UWB communications may be used to transmit/receive certain type of information between anchor units for clock offset determination while ISM band communications may be used to transmit/receive other type of information between anchor units for clock offset determination.

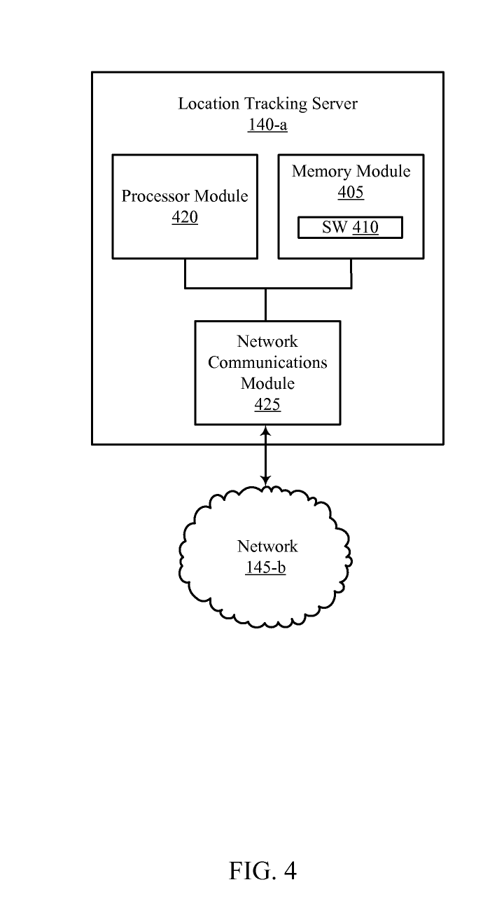

Turning to FIG. 4, a location tracking server 140-a is shown that may be an example of the location tracking server 140 of FIG. 1. The location tracking server 140-a includes a memory module 405, a processor module 420, and a network communications module 425. Each of these components may be in communication, directly or indirectly.

The memory module 405 may include RAM and ROM. The memory module 405 may also store computer-readable, computer-executable software code 410 containing instructions that are configured to, when executed, cause the processor module 420 to perform various functions described herein (e.g., range measurements, distance calculations, clock offset determination, candidate space selection, candidate space ranking, energy transmission and detection scheduling, candidate space identification). Alternatively, the software code 410 may not be directly executable by the processor module 420 but be configured to cause the computer, e.g., when compiled and executed, to perform functions described herein.

The processor module 420 may include an intelligent hardware device, e.g., a CPU such as those made by Intel® Corporation or AMD®, a microcontroller, an ASIC, etc. The processor module 420 may perform various operations associated with synchronizing anchor units. For example, the processor module 420 may be used to schedule the transmission of data from one or more anchor units to one or more other anchor units to determine clock offsets. The processor module 420 may process information from one or more anchor units. For example, the processor module 420 may process information for range measurements, distance calculations, and clock offset determination. In some cases, the location tracking server 140-a may communicate with a network 145-b through the network communications module 425 to receive information from the anchor units and/or to send information to the anchor units. The network 145-b may be an example of the networks 145 and 145-a of FIG. 1 and FIG. 3, respectively.

The processor module 420 may be used to determine or identify a set of candidate spaces within which a mobile tag unit is likely to be located. The processor module 420 may use errors in the location estimate of the mobile tag unit to determine the set of candidate spaces. The set of candidate spaces may also be referred to as an ambiguity list. The processor module 420 may then schedule a series of energy signal transmissions by fixed tag units and may provide information about the schedule to one or more anchor units, which in turn provide instructions to the fixed tag units to make the energy signal transmissions. The processor module 420 may also schedule a series of periods for energy signal detection by a mobile tag unit and may provide information about the schedule to one or more anchor units, which in turn provide instructions to the mobile tag unit to detect energy signal transmissions.

In some embodiments, the processor module 420 may schedule energy signal transmissions during a particular period of time by a mobile tag unit and may provide information about the schedule to one or more anchor units, which in turn provide instructions to the mobile tag unit to make the energy signal transmissions. The processor module 420 may also schedule a corresponding period of time for energy signal detection by fixed tag units and may provide information about the schedule to one or more anchor units, which in turn provide instructions to the fixed tag units to detect the energy signal transmissions.

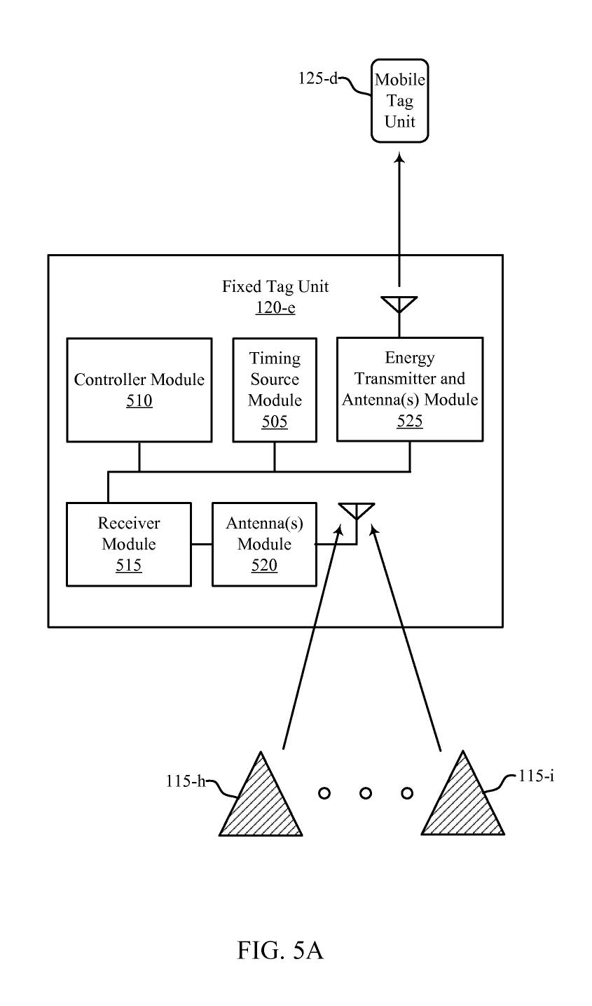

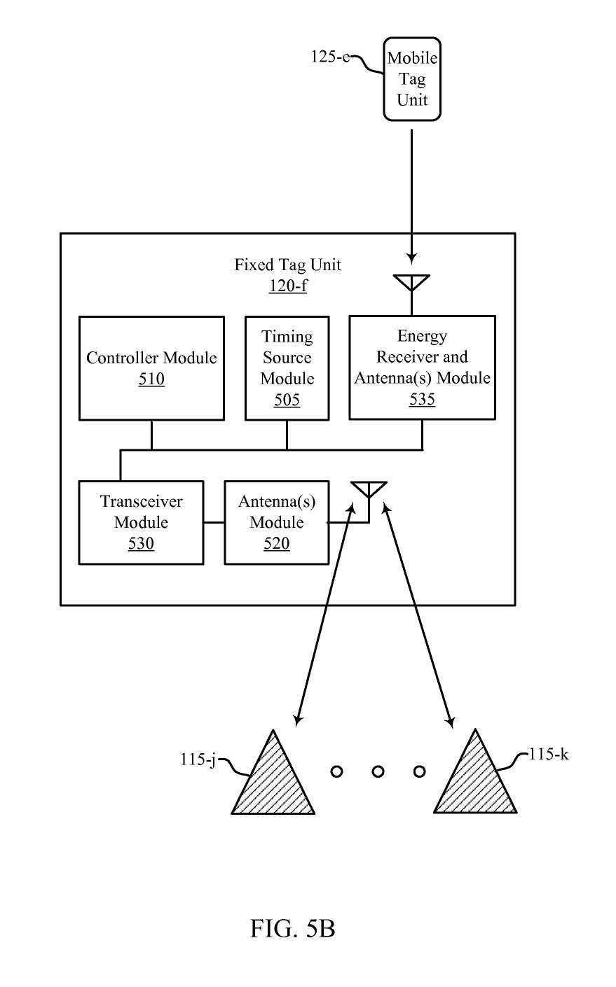

Turning now to FIG. 5A, there is shown a fixed tag unit 120-e that may be an example of the fixed tag units 120, 120-a, and 120-c through 120-d of FIG. 1, FIG. 2A, and FIG. 3, respectively. The fixed tag unit 120-e includes a timing source module 505, a controller module 510, a receiver module 515, an antenna(s) module 520, and an energy transmitter and antenna(s) module 525. Although not shown in FIG. 5A, the fixed tag unit 120-e may also include a battery that enables the fixed tag unit 120-e to be used as a battery-operated device. Each of these components may be in communication, directly or indirectly.

The timing source module 505 produces a clock and/or some other timing signal that is used by the fixed tag unit 120-e to transmit energy signals through the energy transmitter and antenna(s) module 525 at the appropriate times. In some embodiments, the timing source module 505 may include an oscillator and/or a frequency synthesizer that produces the appropriate clock for the operation of the fixed tag unit 120-e.

The controller module 510 may include logic and/or code that enables it to control the operations of the fixed tag unit 120-e. For example, the controller module 510 may include a processor, a microcontroller, and/or a state machine to process an instruction and use the processed instruction to transmit energy signals through the energy transmitter and antenna(s) module 525 at the appropriate time. Moreover, the controller module 510 may wake up the fixed tag unit 120-e from a dormant state in response to an instruction being received and may return the fixed tag unit 120-e to the dormant state after some specified period of time.

The receiver module 515 may receive signals carrying instructions from one or more of the anchor units 115-h through 115-i. The signals may be received through the antenna(s) module 520. While some examples of the antenna(s) module 520 may include a single antenna, the antenna(s) module 520 may include multiple antennas. The receiver module 515 may include a demodulator (not shown) to obtain the instructions from the received signals, which are then used for transmitting energy signals through the energy transmitter and antenna(s) module 525 at the appropriate times.

The energy transmitter and antenna(s) module 525 may generate and transmit energy signals (e.g., ultrasound signals, optical signals) to a mobile tag unit 125-d based on instructions received by the fixed tag unit 120-e. While some examples of the energy transmitter and antenna(s) module 525 may include a single antenna, the energy transmitter and antenna(s) module 525 may include multiple antennas.

The energy transmitter and antenna(s) module 525 may typically send energy signals that correspond to bursts of energy and do not include any bit-level information associated with the fixed tag unit 120-e. In some embodiments, the energy signals may include one or more bits of information of the fixed tag unit 120-e and the mobile tag unit 125-d may be able to retrieve this information from a detected energy signal and report the information along with reporting that an energy signal is detected. The information of the fixed tag unit 120-e may be used by a location tracking server (e.g., location tracking server 140) to more accurately identify the space where the mobile tag unit 125-d is located.

Turning now to FIG. 5B, there is shown a fixed tag unit 120-f that may be an example of the fixed tag units 120, 120-b, and 120-c through 120-d of FIG. 1, FIG. 2B, and FIG. 3, respectively. The fixed tag unit 120-f includes the timing source module 505, the controller module 510, and the antenna(s) module 520 of the fixed tag unit 120-e of FIG. 5A, as well as a transceiver module 530 and an energy receiver and antenna(s) module 535. Although not shown in FIG. 5B, the fixed tag unit 120-f may also include a battery that enables the fixed tag unit 120-f to be used as a battery-operated device. Each of these components may be in communication, directly or indirectly.

In this example, the clock produced by the timing source module 505 may be used to enable detection of energy signals through the energy receive and antenna(s) module 535 during the appropriate time periods. The energy signals may be transmitted by a mobile tag unit associated by a particular space as illustrated by a mobile tag unit 125-e. The controller module 510 may handle instructions that indicate when the fixed tag unit 120-f is to receive energy signals and to ready the energy receiver and antenna(s) module 535 to receive the energy signals. The data having the energy reception instructions may be received by the fixed tag unit 120-f from one or more of anchor units 115-j through 115-k, for example. The energy receiver and antenna(s) module 535 may detect energy signals (e.g., ultrasound signals, optical signals) during a particular period of time when instructed to do so. When an energy signal is detected by energy receiver and antenna(s) module 535, an indication of the energy reception may be generated and the controller module 510 may use the indication to prepare one or more reports. Then, the fixed tag unit 120-f may transmit the one or more reports of the energy signal detection to one or more of the anchor units 115-j through 115-k through the transceiver module 530 and the antenna(s) module 520.

In some embodiments, at least a portion of the features and/or functions of the fixed tag unit 120-e of FIG. 5A and of the fixed tag unit 120-f of FIG. 5B may be combined into a single fixed tag unit.

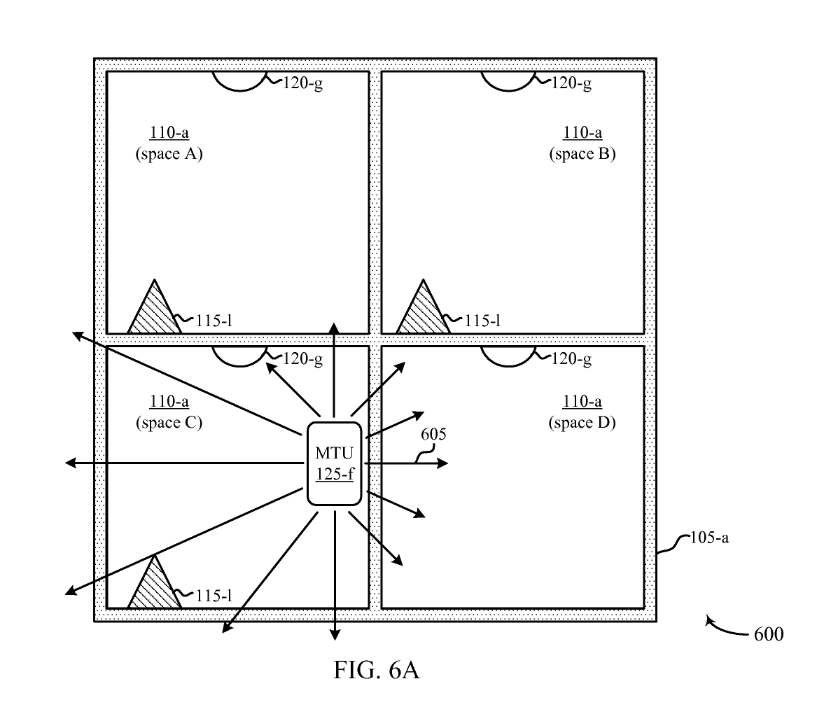

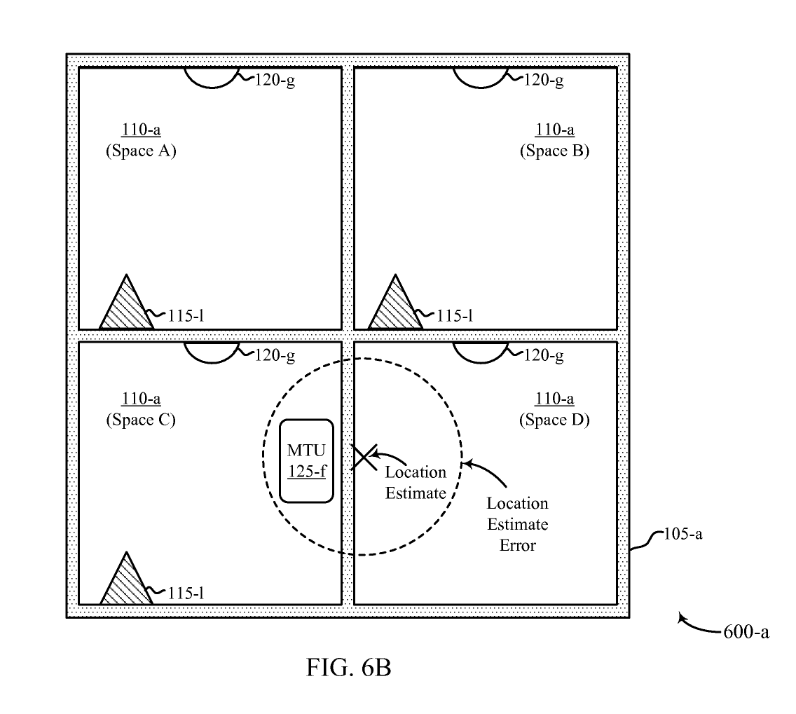

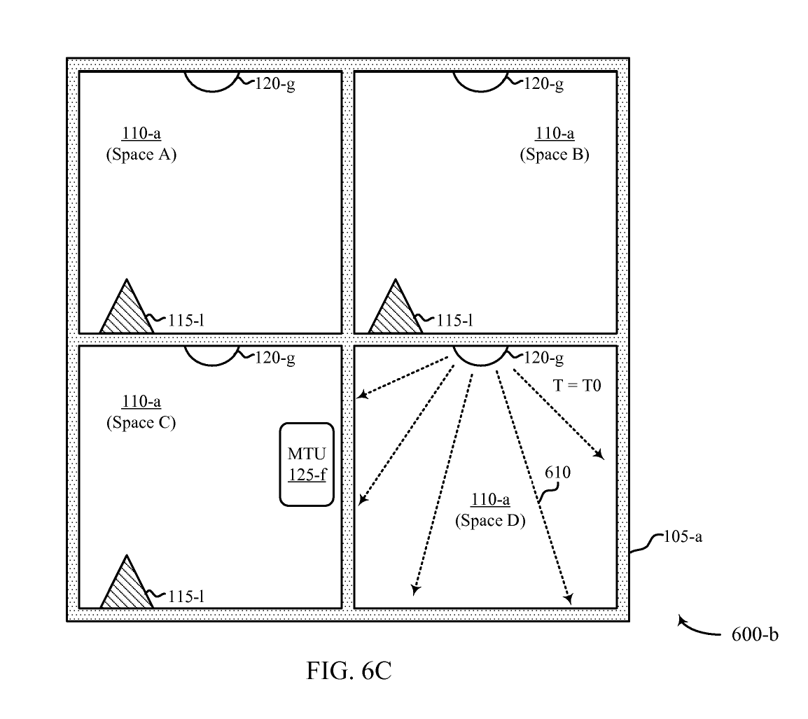

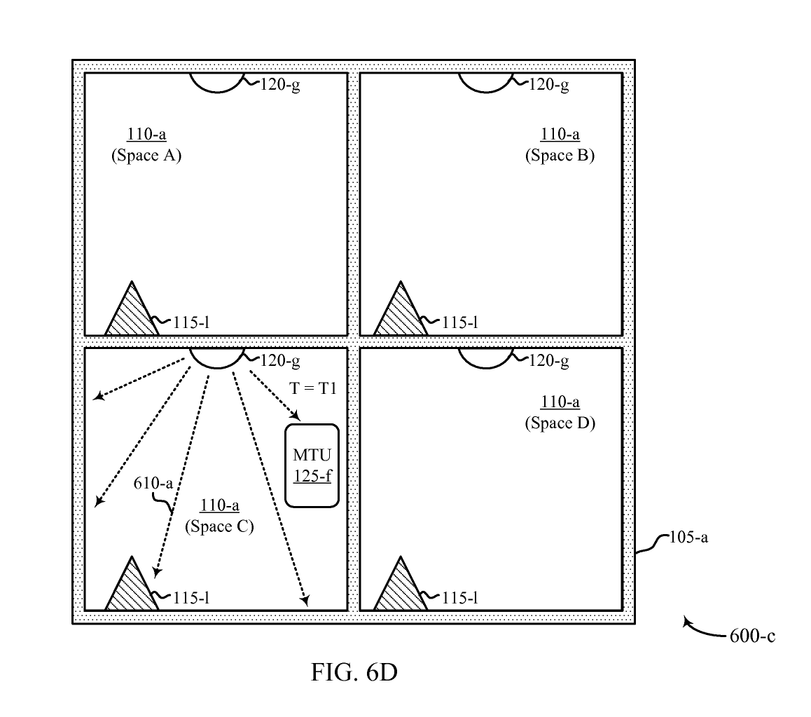

Turning to FIG. 6A, a diagram 600 is shown that illustrates a coverage area 105-a with four spaces 110-a. The four spaces 110-a are labeled space A, space B, space C, and space D. The coverage area 105-a may be an example of the coverage area 105 of FIG. 1 while the spaces 110-a may be examples of the spaces 110 also of FIG. 1. Diagram 600 also shows a mobile tag unit (MTU) 125-f that is located in space C, a fixed tag unit 120-g in each of the four spaces 110-a, and an anchor unit 115-l in each of spaces A, B, and C. The MTU 125-f may be an example of the mobile tag units 125, 125-a, 125-c, and 125-d of FIG. 1, FIG. 2A, FIG. 3, and FIG. 5A, respectively. The anchor units 115-l may be examples of the anchor units 115, 115-a through 115-b, 115-e, 115-f through 115-g, and 115-h through 115-i of FIG. 1, FIG. 2A, FIG. 3, and FIG. 5A. The fixed tag units 120-g may be examples of the fixed tag units 120, 120-a, 120-c through 120-d, and 120-e of FIG. 1, FIG. 2A, FIG. 3, and FIG. 5A, respectively. FIG. 6A is provided by way of illustration and other embodiments may use more or fewer spaces 110-a, anchor units 115-l, and/or fixed tag units 120-g than those shown in FIG. 6A.

During indoor location tracking, the MTU 125-f may be attached to a mobile asset or person and may broadcast preamble signals 605 that identify the MTU 125-f from other mobile tag units. The preamble signals 605 are broadcast by the MTU 125-f using a radio frequency technology such that the preamble signals 605 may penetrate the walls or materials that separate the spaces 110-a. The preamble signals 605 may be received by neighboring the anchor units 115-l, which may make pseudo-range measurements based on the received signals. These measurements may be provided to a location tracking server (e.g., location tracking server 140) to determine or estimate the location of the MTU 125-f and to estimate an error or errors associated with the location estimate.

Turning to FIG. 6B, a diagram 600-a is shown that illustrates an example of the location estimate and the location estimate error for the MTU 125-f of FIG. 6A. As noted above, the MTU 125-f is located in space C, very near the wall or material that separates space C from space D. Because of inaccuracies in triangulation or trilateration calculations, the location estimate resulting from those calculations indicates that the MTU 125-f appears to be initially located in space D and not in space C. In addition to the location estimate, a location estimate error is also determined or generated to indicate a region where the MTU 125-f is likely to be located. The location estimate error is represented by a circle with a large portion of the circle being in space D and a remaining portion of the circle being in space C. This representation is for purposes of illustration and the location estimate error may be represented by non-circular areas. According to the area covered by the location estimate error, both space C and space D are candidate spaces. In this example, the likelihood that the MTU 125-f is located in space D is higher than the likelihood that the MTU 125-f is located in space C because of the larger overlap between the location estimate error area and space D. This information may be used to rank or prioritize the two candidate spaces during a location validation scheme. In this example, space D may be ranked higher than space C and, consequently, space D may be tested first during the location validation scheme.

Turning to FIG. 6C, a diagram 600-b is shown that illustrates validation of space D as a candidate space in the coverage area 105-a of FIG. 6A. In this example, once the candidate spaces are determined and ranked by a location tracking server (e.g., location tracking server 140), a schedule is generated to test each of the candidate spaces to determine where exactly is the MTU 125-f located (i.e., room-level accuracy). The schedule includes providing instructions to the fixed tag unit 120-g in space D, to the fixed tag unit 120-g in space C, and to the MTU 125-f. These instructions may be provided through one or more of the anchor units 115-l and may be based on information received by the anchor units 115-l from the location tracking server.

In FIG. 6C, the fixed tag unit 120-g in space D receives instructions to transmit energy signals 610 at time T=T0. The MTU 125-f receives instructions to detect energy signals during a period of time that includes T=T0. Both the fixed tag unit 120-g and the MTU 125-f may have been in a dormant state until the instructions were received. At T=T0, the energy signals 610 are transmitted and those signals are confined to space D since they do not penetrate the wall or material that separates space C from space D or from the other spaces. As a result, MTU 125-f does not detect the energy signals 610 during the instructed detection period. Consequently, space D may be discarded from the candidate spaces even though the location estimate initially had space D as the space 110-a in the coverage area 105-a within which the MTU 125-f was located. Some time after T=T0, when the fixed tag unit 120-g is no longer transmitting energy signals 610 and the MTU 125-f is no longer trying to detect energy signals, both the fixed tag unit 120-g and the MTU 125-f may return to their dormant state.

Turning to FIG. 6D, a diagram 600-c is shown that illustrates an example of validation of space C as a candidate space in the coverage area 105-a of FIG. 6A. In this example, the fixed tag unit 120-g in space C receives instructions to transmit energy signals 610-a at time T=T1. The MTU 125-f receives instructions to detect energy signals during a period of time that includes T=T1. Both the fixed tag unit 120-g and the MTU 125-f may have been in a dormant state until the instructions were received. At T=T1, the energy signals 610-a are transmitted and those signals are confined to space C since they do not penetrate the wall or material that separates space C from space D or from the other spaces. As a result, MTU 125-f is able to detect the energy signals 610-a during the instructed detection period. Consequently, space C is identified as the candidate space within which the MTU 125-f is located. Some time after T=T1, when the fixed tag unit 120-g is no longer transmitting energy signals 610-a and the MTU 125-f is no longer trying to detect energy signals, both the fixed tag unit 120-g and the MTU 125-f may return to their dormant state.

The MTU 125-f may report that it detected energy signals during a particular detection period corresponding to the transmission of energy signals 610-a by the fixed tag unit 120-g in space C. The MTU 125-f may generate and transmit radio frequency signals with the reporting information, which in turn may be received by one or more of the anchor units 115-l and provided to a location tracking server.

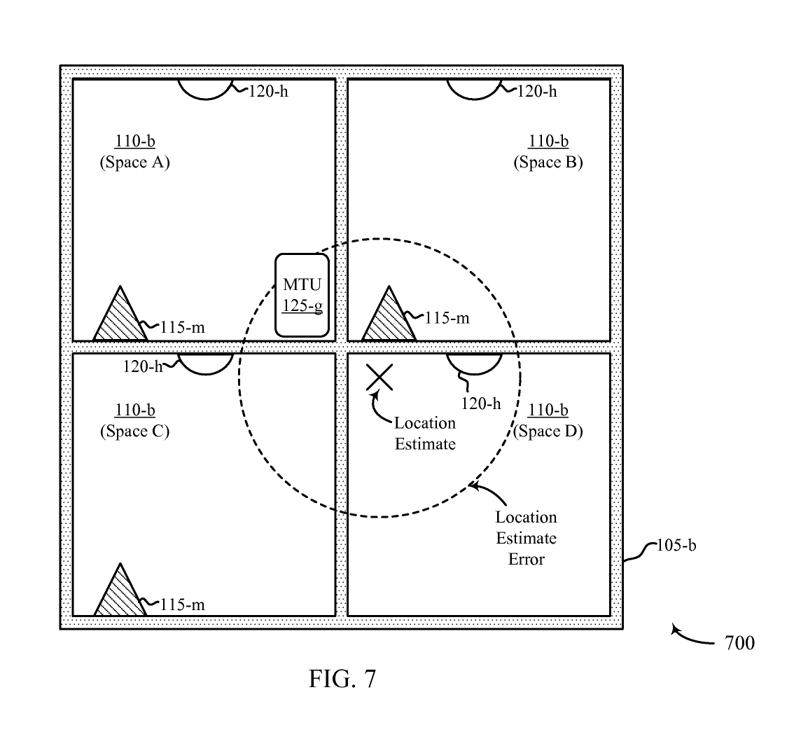

Turning to FIG. 7, a diagram 700 is shown that illustrates an example of validation ranking for an MTU 125-g in a coverage area 105-b. The coverage area 105-b may be an example of the coverage areas 105 and 105-a of FIG. 1 and of FIG. 6A, respectively. The MTU 125-g may be an example of the mobile tag units 125, 125-a, 125-c, 125-d, and 125-f of FIG. 1, FIG. 2A, FIG. 3, FIG. 5A, and FIG. 6A, respectively. The coverage area 105-b includes four spaces 110-b labeled space A, space B, space C, and space D. Like diagram 600 above, diagram 700 also shows a fixed tag unit 120-h in each of the four spaces 110-b and an anchor unit 115-m in each of spaces A, B, and C.

In this example, the MTU 125-g is located in space A, very near the corner that separates all four spaces 110-b. Because of inaccuracies in triangulation or trilateration calculations, the location estimate resulting form those calculations indicates that the MTU 125-g appears to be initially located in space D and not in space A. In addition to the location estimate, a location estimate error is also determined or generated to indicate a region where the MTU 125-g is likely to be located. The location estimate error is represented by a circle with one portion of the circle is space A, another portion in space B, another portion in space C, and a remaining portion in space D. In some instances, the location estimate error may be represented by a non-circular area. Accordingly, space A, space B, space C, and space D are all candidate spaces with the likelihood that the MTU 125-g is located in space D being highest, followed by the likelihood that the MTU 125-g is located in space B, followed by the likelihood that the MTU 125-g is located in space C, and space A having the lowest likelihood that the MTU 125-g is located in that space. This information is used to rank the candidate spaces during a location validation scheme such that space D is tested first, space B is tested next, space C is tested after space B, and space A is tested last. Following a similar approach as the one described above for FIG. 6C and FIG. 6D, the location validation scheme in this example would identify space A as the space within which the MTU 125-g is located even though space A appeared to be the least likely of all the candidate spaces to have the MTU 125-g located within it. Therefore, applying a validation scheme after an initial location estimate may overcome some of the inaccuracies that occur in a location tracking system and may enable a cost-effective way to provide room-level accuracy.

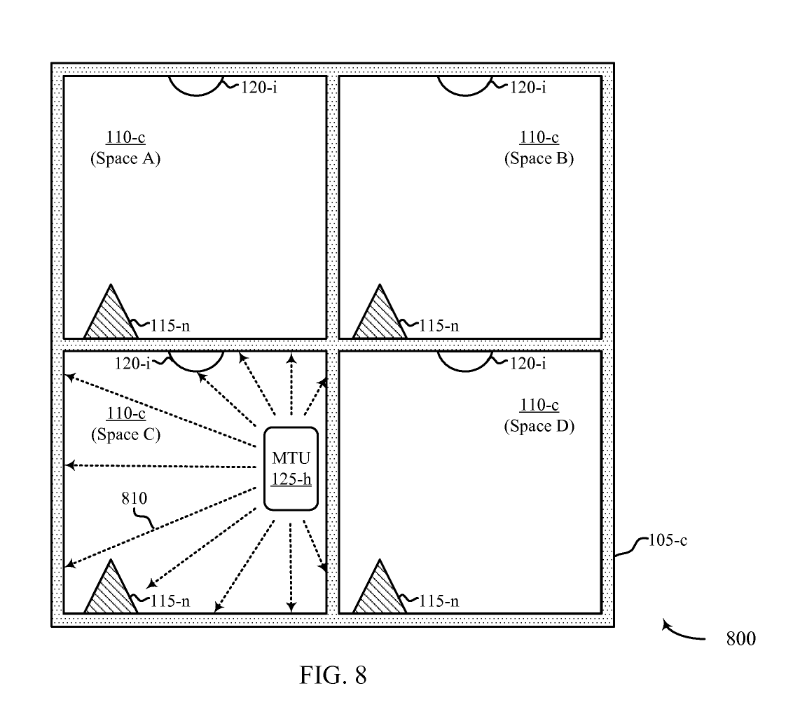

Turning now to FIG. 8, a diagram 800 is shown that illustrates an example of a location validation scheme for an MTU 125-h in a coverage area 105-c. The coverage area 105-c may be an example of the coverage areas 105,105-a, and 105-b of FIG. 1, FIG. 6A, and FIG. 7, respectively. The MTU 125-h may be an example of the mobile tag units described above with reference to FIG. 1, FIG. 2B, FIG. 3, and FIG. 5B. The MTU 125-h, like the mobile tag unit 125-b, may be configured to transmit energy signals when instructed to do so. The coverage area 105-c includes four spaces 110-c labeled space A, space B, space C, and space D, similar to FIGS. 6A-6D and FIG. 7. Like diagrams 600 and 700 above, diagram 800 also shows a fixed tag unit 120-i in each of the four spaces 110-c and an anchor unit 115-n in each of spaces A, B, and C. The fixed tag units 120-i, like the fixed tag unit 120-f, may be configured to detect energy signals transmitted by the MTU 125-h.

In this example, the MTU 125-h is located in space C, very near the wall or material that separates space C from space D. Because of inaccuracies in triangulation or trilateration calculations, the location estimate resulting form those calculations indicates that the MTU 125-h appears to be initially located in space D and not in space C. In addition to the location estimate, a location estimate error is also determined or generated to indicate a region where the MTU 125-h is likely to be located and which spaces are candidate spaces. According to the location estimate error both space C and space D are candidate spaces.

In this example, the MTU 125-h receives instructions to transmit energy signals during a particular period of time. The instructions may be received through one or more of the anchor units 115-n. Similarly, the fixed tag units 120-i in each of the candidate spaces (i.e., spaces C and D) receive instructions to detect energy signals during a particular period of time that corresponds or overlaps with the period of time during which the MTU 125-h is to transmit the energy signals. The MTU 125-h and the fixed tag units 120-i in spaces C and D may have been in a dormant state until the instructions were received. At the appropriate time, the energy signals 810 are transmitted by the MTU 125-h and those signals are confined to space C since they do not penetrate the wall or material that separates space C from space D or from the other spaces. As a result, only the fixed tag unit 120-i in space C is able to detect the energy signals 810 during the instructed detection period. Consequently, space C is identified as the candidate space within which the MTU 125-h is located. Some time later, when the MTU 125-h is no longer transmitting energy signals 810 and the fixed tag units 120-i in spaces C and D are no longer trying to detect energy signals, those devices may return to their dormant state.

After detecting the energy signal, the fixed tag unit 120-i in space C may report that it detected energy signals during the detection period corresponding to the transmission of energy signals 810 by the MTU 125-h. The fixed tag unit 120-i in space C may generate and transmit radio frequency signals with the reporting information, which in turn may be received by one or more of the anchor units 115-n and provided to a location tracking server.

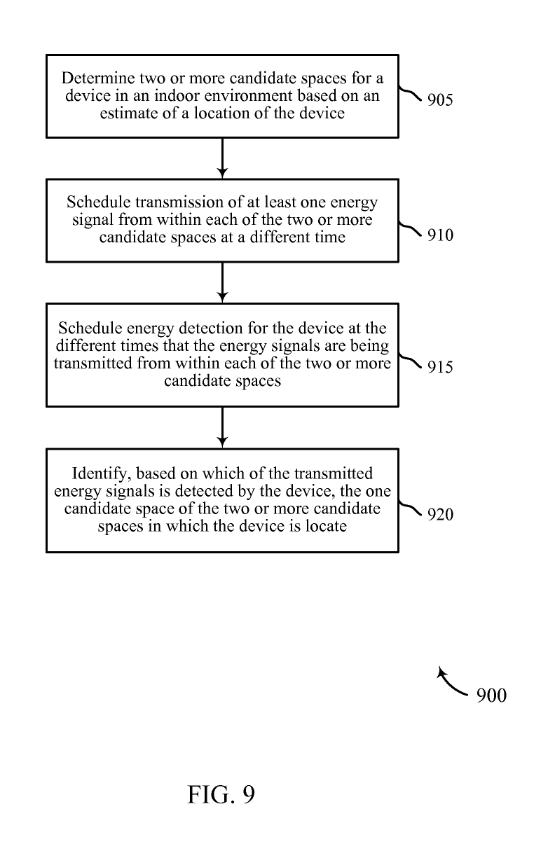

Turning to FIG. 9, a flowchart diagram of an example method 900 for indoor location tracking with a location validation scheme. The method 900 may be performed using, for example, the system 100 of FIG. 1; the mobile tag units 125, 125-a, 125-c, 125-d, 125-f, and 125-g of FIG. 1, FIG. 2A, FIG. 3, FIG. 5A, FIG. 6A-6D, and FIG. 7, respectively; the anchor units 115, 115-a through 115-b, 115-e, 115-f through 115-g, 115-h through 115-i, 115-l, and 115-m of FIG. 1, FIG. 2A, FIG. 3, FIG. 5A, FIG. 6A-6D, and FIG. 7; the fixed tag units 120, 120-a, 120-c through 120-d, 120-e, 120-g, and 120-h of FIG. 1, FIG. 2A, FIG. 3, FIG. 5A, FIG. 6A-6D, and FIG. 7, respectively; and/or the location tracking servers 140 and 140-a of FIG. 1 and FIG. 4, respectively.

At block 905, determine two or more candidate spaces for a device (e.g., mobile tag unit 125) in an indoor environment based on an estimate of a location of the device. At block 910, transmissions of at least one energy signal within each of the candidate spaces are scheduled at a different time. The at least one energy signal may include an ultrasound signal. The at least one energy signal may include an ultrasound signal having one or more bits of information about the corresponding candidate space. At block 915, energy detection for the device is scheduled at the different times that the energy signals are being transmitted from within each of the candidate spaces. At block 920, based on which transmitted energy signal is detected by the device, one of the candidate spaces is identified as the candidate space within which the device is located.

In some embodiments of the method 900, the location estimate of the device is determined based on information in one or more signals transmitted by the device. In some embodiments, each of the candidate spaces is ranked based on the likelihood that the device is located in the candidate space being ranked. Based on the ranking of the candidate spaces, a schedule is determined that coordinates the transmission of energy signals from within each of the candidate spaces and the detection by the device of the transmitted energy signals. In some embodiments, information is received that identifies which of the transmitted energy signals is detected by the device.

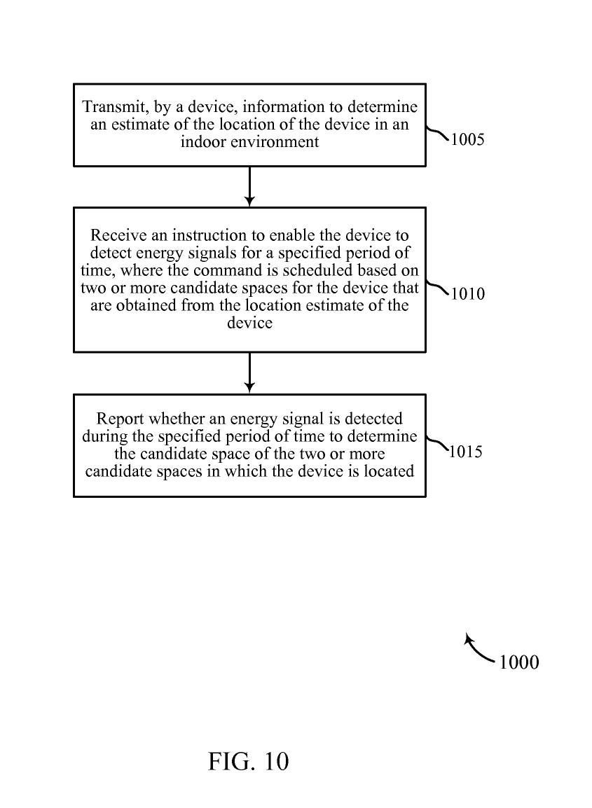

Turning to FIG. 10, a flowchart diagram of an example method 1000 for indoor location tracking with a location validation scheme. The method 1000 may be performed using, for example, the system 100 of FIG. 1; the mobile tag units 125, 125-a, 125-c, 125-d, 125-f, and 125-g of FIG. 1, FIG. 2A, FIG. 3, FIG. 5A, FIG. 6A-6D, and FIG. 7, respectively; the anchor units 115, 115-a through 115-b, 115-e, 115-f through 115-g, 115-h through 115-i, 115-l, and 115-m of FIG. 1, FIG. 2A, FIG. 3, FIG. 5A, FIG. 6A-6D, and FIG. 7; the fixed tag units 120, 120-a, 120-c through 120-d, 120-e, 120-g, and 120-h of FIG. 1, FIG. 2A, FIG. 3, FIG. 5A, FIG. 6A-6D, and FIG. 7, respectively; and/or the location tracking servers 140 and 140-a of FIG. 1 and FIG. 4, respectively.

At block 1005, a device (e.g., mobile tag unit 125) may transmit information to determine an estimate of the location of the device in an indoor environment. At block 1010, an instruction is received to enable the device to detect energy signals for a specified period of time, where the instruction is scheduled based on two or more candidate spaces for the device that are obtained from the location estimate of the device. At block 1015, a report is made of whether an energy signal is detected during the specified period of time to determine the one candidate space from the candidate spaces in which the device is located.

In some embodiments of the method 1000, during the specified period of time, an energy signal that includes an ultrasound signal is detected. In some embodiments, during the specified period of time, an energy signal that includes an ultrasound signal having one or more bits of information about the corresponding candidate space is detected. In some embodiments, the device is woken up from a dormant state in response to the instruction being received and the device is returned to the dormant state in response to the specified period of time being over.

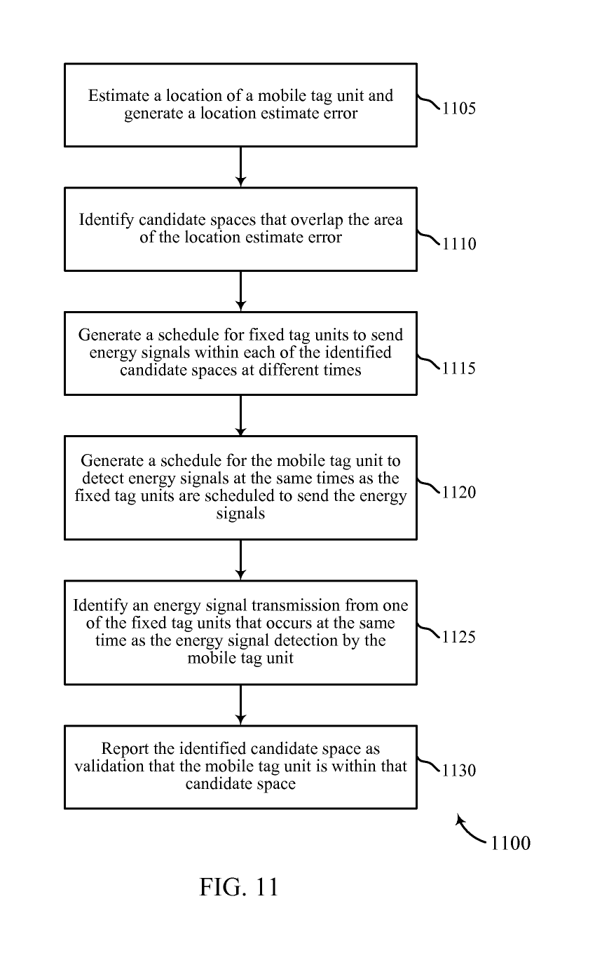

Turning to FIG. 11, a flowchart diagram of an example method 1100 for indoor location tracking with a location validation scheme. The method 1100 may be performed using, for example, the system 100 of FIG. 1; the mobile tag units 125, 125-a, 125-c, 125-d, 125-f, and 125-g of FIG. 1, FIG. 2A, FIG. 3, FIG. 5A, FIG. 6A-6D, and FIG. 7, respectively; the anchor units 115, 115-a through 115-b, 115-e, 115-f through 115-g, 115-h through 115-i, 115-l, and 115-m of FIG. 1, FIG. 2A, FIG. 3, FIG. 5A, FIG. 6A-6D, and FIG. 7; the fixed tag units 120, 120-a, 120-c through 120-d, 120-e, 120-g, and 120-h of FIG. 1, FIG. 2A, FIG. 3, FIG. 5A, FIG. 6A-6D, and FIG. 7, respectively; and/or the location tracking servers 140 and 140-a of FIG. 1 and FIG. 4, respectively.

At block 1105, a location of a mobile tag unit (e.g., mobile tag unit 125) may be estimated and a location estimate error may be generated. At block 1110, candidate spaces that overlap the area of the location estimate error are identified. At block 1115, a schedule is generated for fixed tag units (e.g., fixed tag units 120) to send energy signals within each of the identified candidate spaces at different times. At block 1120, a schedule is generated for the mobile tag unit to detect energy signals at the same times at the same times as the fixed tag units are scheduled to send the energy signals. At block 1125, an energy signal transmission from one of the fixed tag units that occurs at the same time as the energy signal detection at the mobile tag unit is identified. At block 1130, a report is made of the identified candidate space as validation that the mobile tag unit is within that candidate space.

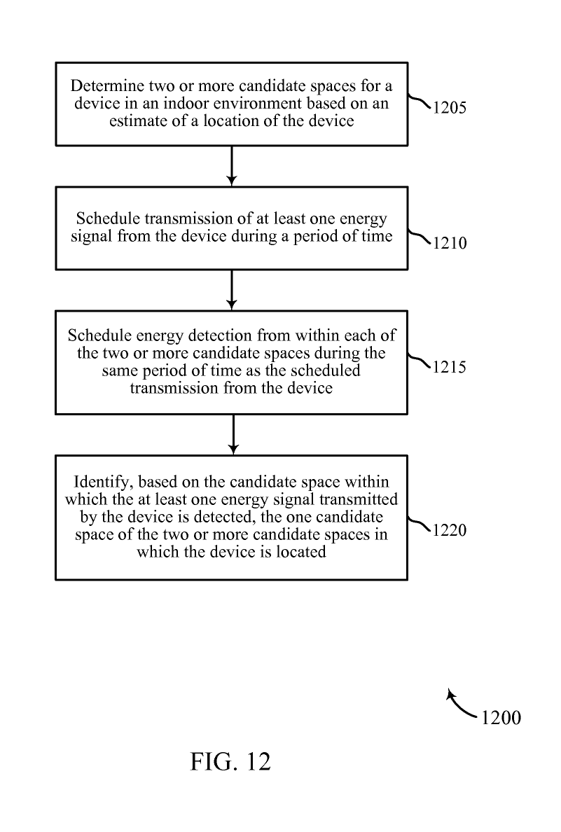

Turning to FIG. 12, a flowchart diagram of an example method 1200 for indoor location tracking with a location validation scheme. The method 1200 may be performed using, for example, the system 100 of FIG. 1; the mobile tag units 125, 125-b, 125-c, 125-e, and 125-h of FIG. 1, FIG. 2B, FIG. 3, FIG. 5B, and FIG. 8, respectively; the anchor units 115, 115-c through 115-d, 115-e, 115-f through 115-g, 115-j through 115-k, and 115-n of FIG. 1, FIG. 2B, FIG. 3, FIG. 5B, and FIG. 8; the fixed tag units 120, 120-b, 120-c through 120-d, 120-f, and 120-i of FIG. 1, FIG. 2B, FIG. 3, FIG. 5B, and FIG. 8, respectively; and/or the location tracking servers 140 and 140-a of FIG. 1 and FIG. 4, respectively.

At block 1205, two or more candidate spaces for a device (e.g., mobile tag unit 125) in an indoor environment are determined based on an estimate of a location of the device. At block 1210, transmissions of at least one energy signal from the device are scheduled for a period of time. The at least one energy signal may include an ultrasound signal. The at least one energy signal may include an ultrasound signal having one or more bits of information about the device to indentify the device from other devices. At block 1215, energy detection is scheduled from within each of the candidate spaces during the same period of time as the period of time for the transmissions of the energy signals by the device. In some embodiments, the period of time for detection need only overlap the period of time for transmission of the energy signals. At block 1220, based on the candidate space within which the at least one energy signal transmitted by the device is detected, the one candidate space of the two or more candidate spaces in which the device is located is identified.

Techniques described herein may be used in connection with various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, instructions, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for indoor tracking, comprising:
determining two or more candidate spaces for a device in an indoor environment based on an estimate of a location of the device;
scheduling transmission of at least one energy signal from within each of the two or more candidate spaces at a different time;
scheduling energy detection for the device at the different times that the energy signals are being transmitted from within each of the two or more candidate spaces; and
identifying, based on which of the transmitted energy signals is detected by the device, the one candidate space of the two or more candidate spaces in which the device is located.

2. The method of claim 1, further comprising:
determining the location estimate of the device based on information in one or more signals transmitted by the device.

3. The method of claim 1, further comprising:
ranking each of the two or more candidate spaces based on the likelihood that the device is located in the candidate space being ranked.

4. The method of claim 3, further comprising:
determining, based on the ranking of the two or more candidate spaces, a schedule that coordinates the transmission of energy signals from within each of the two or more candidate spaces and the detection by the device of the transmitted energy signals.

5. The method of claim 1, further comprising:
receiving information that identifies which of the transmitted energy signals is detected by the device.

6. The method of claim 1, wherein the at least one energy signal includes an ultrasound signal.

7. The method of claim 1, wherein the at least one energy signal includes an ultrasound signal having one or more bits of information about the corresponding candidate space.

8. A method for indoor tracking, comprising:
transmitting, by a device, information to determine an estimate of a location of the device in an indoor environment;
receiving an instruction to enable the device to detect energy signals for a specified period of time, the instruction being scheduled based on two or more candidate spaces for the device that are obtained from the location estimate of the device; and
reporting whether an energy signal is detected during the specified period of time to determine the candidate space of the two or more candidate spaces in which the device is located.

9. The method of claim 8, further comprising:
detecting during the specified period of time, an energy signal that includes an ultrasound signal.

10. The method of claim 8, further comprising:
detecting during the specified period of time, an energy signal that includes an ultrasound signal having one or more bits of information about the corresponding candidate space.

11. The method of claim 8, further comprising:
waking up the device from a dormant state in response to the instruction being received; and
returning the device to the dormant state in response to the specified period of time being over.

12. A system for indoor tracking, comprising:
means for determining two or more candidate spaces for a device in an indoor environment based on an estimate of a location of the device;
means for scheduling transmission of at least one energy signal from within each of the two or more candidate spaces at a different time;
means for scheduling energy detection for the device at the different times that the energy signals are being transmitted from within each of the two or more candidate spaces; and
means for identifying, based on which of the transmitted energy signals is detected by the device, the one candidate space of the two or more candidate spaces in which the device is located.

13. The system of claim 12, further comprising:
means determining the location estimate of the device based on information in one or more signals transmitted by the device.

14. The system of claim 12, further comprising:
means for ranking each of the two or more candidate spaces based on the likelihood that the device is located in the candidate space being ranked.

15. The system of claim 14, further comprising:
means for determining, based on the ranking of the two or more candidate spaces, a schedule that coordinates the transmission of energy signals from within each of the two or more candidate spaces and the detection by the device of the transmitted energy signals.

16. The system of claim 12, further comprising:
means for receiving information that identifies which of the transmitted energy signals is detected by the device.

17. The system of claim 12, wherein the at least one energy signal includes an ultrasound signal.

18. The system of claim 12, wherein the at least one energy signal includes an ultrasound signal having one or more bits of information about the corresponding candidate space.

19. A system for indoor tracking, comprising:
means for transmitting, by a device, information to determine an estimate of a location of the device in an indoor environment;
means for receiving an instruction to enable the device to detect energy signals for a specified period of time, the instruction being scheduled based on two or more candidate spaces for the device that are obtained from the location estimate of the device; and
means for reporting whether an energy signal is detected during the specified period of time to determine the candidate space of the two or more candidate spaces in which the device is located.

20. The system of claim 19, further comprising:
means for detecting during the specified period of time, an energy signal that includes an ultrasound signal.

21. The system of claim 19, further comprising:
means for detecting during the specified period of time, an energy signal that includes an ultrasound signal having one or more bits of information about the corresponding candidate space.

22. The system of claim 19, further comprising:
means for waking up the device from a dormant state in response to the instruction being received; and
means for returning the device to the dormant state in response to the specified period of time being over.

23. A device for indoor tracking, comprising:
at least one processor communicatively coupled with a memory, the memory comprising executable code that, when executed by the at least one processor, causes the at least one processor to:
determine two or more candidate spaces for the device in an indoor environment based on an estimate of a location of the device;
schedule transmission of at least one energy signal from within each of the two or more candidate spaces at a different time;
schedule energy detection for the device at the different times that the energy signals are being transmitted from within each of the two or more candidate spaces; and
identify, based on which of the transmitted energy signals is detected by the device, the one candidate space of the two or more candidate spaces in which the device is located.

24. The device of claim 23, wherein the executable code causes the at least one processor to:
determine the location estimate of the device based on information in one or more signals transmitted by the device.

25. The device of claim 23, wherein the executable code causes the at least one processor to:
rank each of the two or more candidate spaces based on the likelihood that the device is located in the candidate space being ranked.

26. The device of claim 25, wherein the executable code causes the at least one processor to:
determine, based on the ranking of the two or more candidate spaces, a schedule that coordinates the transmission of energy signals from within each of the two or more candidate spaces and the detection by the device of the transmitted energy signals.

27. The device of claim 23, wherein the executable code causes the at least one processor to:
receive information that identifies which of the transmitted energy signals is detected by the device.

28. The device of claim 23, wherein the at least one energy signal includes an ultrasound signal.

29. The device of claim 23, wherein the at least one energy signal includes an ultrasound signal having one or more bits of information about the corresponding candidate space.

30. A device for indoor tracking, comprising:
at least one processor communicatively coupled with a memory, the memory comprising executable code that, when executed by the at least one processor, causes the at least one processor to:
transmit information to determine an estimate of a location of the device in an indoor environment;
receive an instruction to enable the device to detect energy signals for a specified period of time, the instruction being scheduled based on two or more candidate spaces for the device that are obtained from the location estimate of the device; and
report whether an energy signal is detected during the specified period of time to determine the candidate space of the two or more candidate spaces in which the device is located.

31. The device of claim 30, wherein the executable code causes the at least one processor to:
detect during the specified period of time, an energy signal that includes an ultrasound signal.

32. The device of claim 30, wherein the executable code causes the at least one processor to:
detect during the specified period of time, an energy signal that includes an ultrasound signal having one or more bits of information about the corresponding candidate space.

33. The device of claim 30, wherein the executable code causes the at least one processor to:
wake up the device from a dormant state in response to the instruction being received; and
return the device to the dormant state in response to the specified period of time being over.

34. A computer program product for indoor tracking, comprising:
a non-transitory computer-readable medium comprising:
code configured to determine two or more candidate spaces for a device in an indoor environment based on an estimate of a location of the device;
code configured to schedule transmission of at least one energy signal from within each of the two or more candidate spaces at a different time;
code configured to schedule energy detection for the device at the different times that the energy signals are being transmitted from within each of the two or more candidate spaces; and
code configured to identify, based on which of the transmitted energy signals is detected by the device, the one candidate space of the two or more candidate spaces in which the device is located.

35. The computer program product of claim 34, wherein the non-transitory computer-readable medium comprises:
code configured to determine the location estimate of the device based on information in one or more signals transmitted by the device.

36. The computer program product of claim 34, wherein the non-transitory computer-readable medium comprises:
code configured to rank each of the two or more candidate spaces based on the likelihood that the device is located in the candidate space being ranked.

37. The computer program product of claim 36, wherein the non-transitory computer-readable medium comprises:
code configured to determine, based on the ranking of the two or more candidate spaces, a schedule that coordinates the transmission of energy signals from within each of the two or more candidate spaces and the detection by the device of the transmitted energy signals.

38. The computer program product of claim 34, wherein the non-transitory computer-readable medium comprises:
code configured to receive information that identifies which of the transmitted energy signals is detected by the device.

39. The computer program product of claim 34, wherein the at least one energy signal includes an ultrasound signal.

40. The computer program product of claim 34, wherein the at least one energy signal includes an ultrasound signal having one or more bits of information about the corresponding candidate space.

41. A computer program product for indoor tracking, comprising:
a non-transitory computer-readable medium comprising:
code configured to transmit, by a device, information to determine an estimate of a location of the device in an indoor environment;
code configured to receive an instruction to enable the device to detect energy signals for a specified period of time, the instruction being scheduled based on two or more candidate spaces for the device that are obtained from the location estimate of the device; and
code configured to report whether an energy signal is detected during the specified period of time to determine the candidate space of the two or more candidate spaces in which the device is located.

42. The computer program product of claim 41, wherein the non-transitory computer-readable medium comprises:
code configured to detect during the specified period of time, an energy signal that includes an ultrasound signal.

43. The computer program product of claim 41, wherein the non-transitory computer-readable medium comprises:
code configured to detect during the specified period of time, an energy signal that includes an ultrasound signal having one or more bits of information about the corresponding candidate space.

44. The computer program product of claim 41, wherein the non-transitory computer-readable medium comprises:
code configured to wake up the device from a dormant state in response to the instruction being received; and
code configured to return the device to the dormant state in response to the specified period of time being over.

45. A method for indoor tracking, comprising:
determining two or more candidate spaces for a device in an indoor environment based on an estimate of a location of the device;
scheduling transmission of at least one energy signal from the device during a period of time;
scheduling energy detection from within each of the two or more candidate spaces during the same period of time as the scheduled transmission from the device; and
identifying, based on the candidate space within which the at least one energy signal transmitted by the device is detected, the one candidate space of the two or more candidate spaces in which the device is located.

46. The method of claim 45, further comprising:
determining the location estimate of the device based on information in one or more signals transmitted by the device.

47. The method of claim 45, wherein the at least one energy signal includes an ultrasound signal.

48. A system for indoor tracking, comprising:
means for determining two or more candidate spaces for a device in an indoor environment based on an estimate of a location of the device;
means for scheduling transmission of at least one energy signal from the device during a period of time;
means for scheduling energy detection from within each of the two or more candidate spaces during the same period of time as the scheduled transmission from the device; and
means for identifying, based on the candidate space within which the at least one energy signal transmitted by the device is detected, the one candidate space of the two or more candidate spaces in which the device is located.

49. The system of claim 48, further comprising:
means for determining the location estimate of the device based on information in one or more signals transmitted by the device.

50. The system of claim 48, wherein the at least one energy signal includes an ultrasound signal.

51. A device for indoor tracking, comprising:
at least one processor communicatively coupled with a memory, the memory comprising executable code that, when executed by the at least one processor, causes the at least one processor to:
determine two or more candidate spaces for a device in an indoor environment based on an estimate of a location of the device;
schedule transmission of at least one energy signal from the device during a period of time;
schedule energy detection from within each of the two or more candidate spaces during the same period of time as the scheduled transmission from the device; and
identify, based on the candidate space within which the at least one energy signal transmitted by the device is detected, the one candidate space of the two or more candidate spaces in which the device is located.

52. The device of claim 51, wherein the executable code causes the at least one processor to:
determine the location estimate of the device based on information in one or more signals transmitted by the device.

53. The device of claim 51, wherein the at least one energy signal includes an ultrasound signal.

54. A computer program product for indoor tracking, comprising:
a non-transitory computer-readable medium comprising:
code configured to determine two or more candidate spaces for a device in an indoor environment based on an estimate of a location of the device;
code configured to schedule transmission of at least one energy signal from the device during a period of time;
code configured to schedule energy detection from within each of the two or more candidate spaces during the same period of time as the scheduled transmission from the device; and
code configured to identify, based on the candidate space within which the at least one energy signal transmitted by the device is detected, the one candidate space of the two or more candidate spaces in which the device is located.

55. The computer program product of claim 54, wherein the non-transitory computer-readable medium comprises:
code configured to determine the location estimate of the device based on information in one or more signals transmitted by the device.

56. The computer program product of claim 54, wherein the at least one energy signal includes an ultrasound signal.
